(19) United States
(12) Patent Application Publication
(10) Pub. No.: US 2007/0138968 A1
(43) Pub. Date: Jun. 21, 2007

(54) Power adaptor for christmas light string

(76) Inventor: Ming-Huang Chang, Dongguan (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/304,554

(22) Filed: Dec. 16, 2005

(51) Int. Cl. H05B 37/00

(52) U.S. Cl. 315/185 R

(57) ABSTRACT

A power adaptor for Christmas light string can transfer the electrical power of the Christmas light string into a rectified electrical power and supply to ornaments. The Christmas light string has a plurality of sockets. The PCB is received in the insulative housing. The PCB has at least one output connector for supplying electrical power to ornaments and a switch mounted thereon. The plug is electrically coupled to the PCB, and inserted into one of the socket of the Christmas light string. The plug has a pair of contacts. The rectifier means is mounted on the PCB for rectifying AC power to DC power and transmitting the DC power to the output connector through the switch.

### BACKGROUND OF THE INVENTION

1. Field of the invention

The present invention relates to a power adaptor for Christmas light string and, more particularly, to a power adaptor plugged in one socket of the Christmas light string for supplying electrical power with rectified voltage to electronic appliances.

2. Description of Related Art

To produce visual or musical effects, most Christmas ornaments need electric power. Some ornaments need AC (alternating current) electric power which usually are plugged in plug directly, and some ornaments need DC (direct current) electric power which usually use battery. However the DC ornaments have much inconvenience, such as spending additional battery expense, and battery lifespan is short and limited . . . etc.

There are some prior arts try to use the power of Christmas light string, such as U.S. Pat. No. 6,612,864, which is published on Sep. 2, 2003. The prior art relates to a lighting string with extending structure, which includes an electrical wire with several bulb assemblies and some lighting units connected by an extending wire.

However the prior art only extends electrical power from one socket on the light string to one lighting unit. The usage is limited and other ornament cannot be applied on the prior art. If the lighting unit goes out of fashion or is bad, a complex power-supply system in the lighting unit is wasted.

### SUMMARY OF THE INVENTION

An object of the present invention is to provide a power adaptor for Christmas light string, which can transfer the electrical power of the Christmas light string into a rectified electrical power and supply to ornaments.

Another object of the present invention is to provide a power adaptor for Christmas light string, which can transfer the AC electrical power of the Christmas light string into a DC electrical power and supply to ornaments.

To achieve the above objects, the present invention provides a power adaptor for Christmas light string, which includes an insulative housing, a PCB, a plug, and a rectifier means. The Christmas light string has a plurality of sockets. The PCB is received in the insulative housing. The PCB has at least one output connector for supplying electrical power to ornaments and a switch mounted thereon. The plug is electrically coupled to the PCB, and inserted into one of the socket of the Christmas light string. The plug has a pair of contacts. The rectifier means is mounted on the PCB for rectifying AC power to DC power and transmitting the DC power to the output connector through the switch.

### BRIEF DESCRIPTION OF THE DRAWINGS:

The various objects and advantages of the present invention will be more readily understood from the following detailed description when read in conjunction with the appended drawing, in which:

FIG. 1 is a perspective view of a power adaptor for Christmas light string of the present invention with a Christmas light string;

FIG. 2 is a perspective exploded view of a power adaptor for Christmas light string according to the present invention;

FIG. 3 is a schematic diagram of electrical circuitry of the power adaptor coupled with electrical appliances according to the present invention:

FIG. 4 is a perspective view of the power adaptor for Christmas light string of second embodiment according to the present invention; and

FIG. 5 is a perspective view of the power adaptor for Christmas light string of third embodiment according to the present invention.

### DETAILED DESCRIPTION OF THE PREFERRED EMBODIMENTS

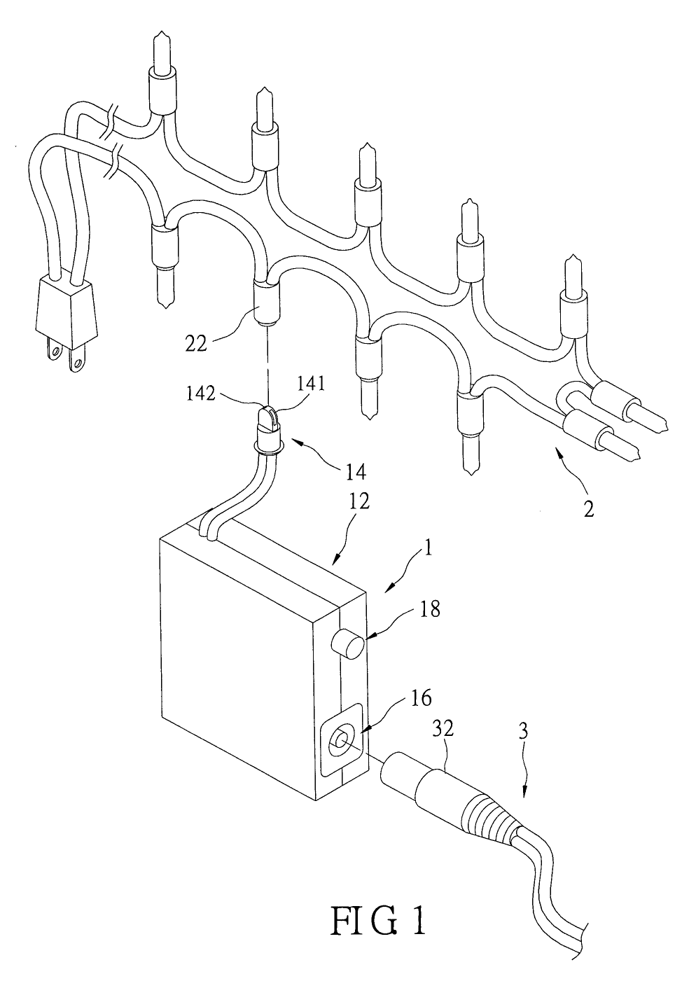

Referring is made in FIG. 1, which is a perspective view of a power adaptor for Christmas light string of the present invention with a Christmas light string. The present invention provides a power adaptor for Christmas light string 1, which is electrically coupled to the Christmas light string 2 to transfer AC power to DC power and transmit to an ornament 3. The Christmas light string 2 has a plurality of sockets 22.

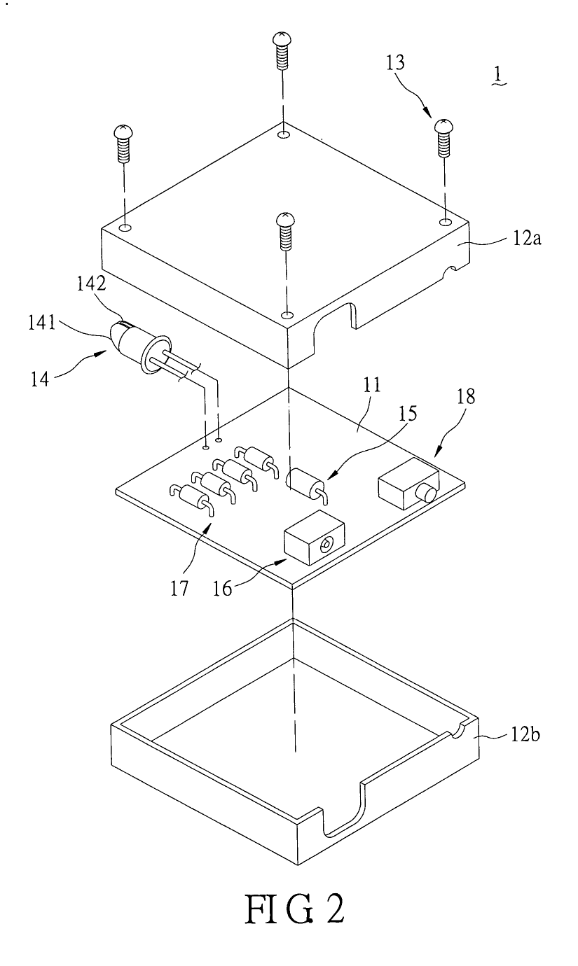

Referring is made in FIG. 2, which is a perspective exploded view of a power adaptor for Christmas light string according to the present invention. The power adaptor 1 has an insulative housing 12 and a PCB 11 that is received in the insulative housing 12. In this embodiment, the insulative housing 12 is composed with two half-housings 12a, 12b and defines a receiving space for receiving the PCB 11. The two half-housings 12a, 12b are screwed to each other by four screws 13.

The PCB 11 has an output connector (in this embodiment is a jack 16) and a switch 18 that is mounted thereon. The jack 16 is used to connect to a plug 32 of an ornament 3 (the ornament 3 only partially shown in FIG. 1) for supplying electrical power. The switch 18 can interrupt electricity transmitted to the jack 16.

A plug 14 is electrically coupled to the PCB 11, and inserted into one socket 22 of the Christmas light string 2. The plug 14 has a pair of contacts 141, 142. A protective element 15 is mounted on the PCB 11.

The present invention has a rectifier means, which is mounted on the PCB 11 for rectifying AC power to DC power and transmitting the DC power to the jack 16 through the switch 18.

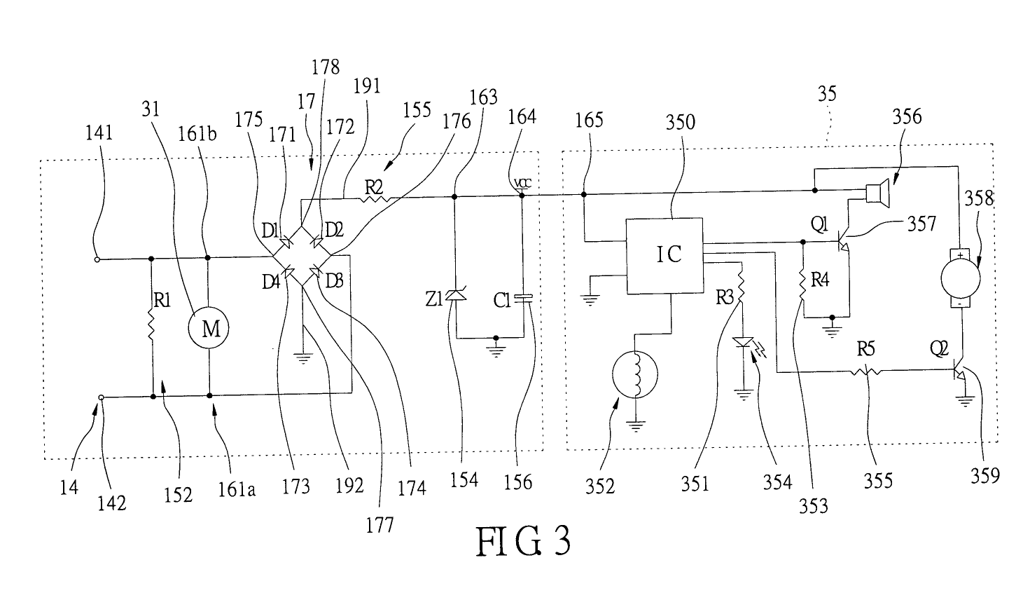

Referring is made in FIG. 3, which is a schematic diagram of electrical circuitry of the power adaptor coupled with electrical appliances according to the present invention. According to the electrical circuitry in this embodiment, the rectifier means has a first resistor 152 and a bridge rectifier 17 that is formed by four bridge diodes 171, 172, 173, 174. The resistor 152 is electrically coupled with the pair of contacts 141, 142 of the plug 14 in a parallel-serial way. The contact 141 is connected to an input terminal 175 of the bridge rectifier 17, and the contact 142 is connected to an input terminal 176 of the bridge rectifier 17.

The present invention can provide a AC jack for AC electronic appliance, such as an AC motor 31 connected to a pair of AC output terminals 161a, 161b. The bridge rectifier 17 has a plus output terminal 178 and a minus output terminal 177. The plus output terminal 178 is connected to a positive voltage supply line 191, and the minus output terminal 177 is connected to a negative voltage supply line 192.

To provide a good protection against irregular voltage, the power adaptor for Christmas light string 1 further has a Zener diode 154 that is connected between the output terminals 177, 178 of the bridge rectifier 17, and a capacitor 156 that is connected to the supply line 192 and an output terminal 164 on the supply line 191. The capacitor 156 is parallel connecting with the Zener diode 154 and is used to maintain in a charged condition, and the Zener diode 154 is used to maintain in filtering out voltage variations produced in the rectification process.

The power adaptor 1 can connect with a plurality of jacks for connecting with many electronic appliances. It only connects two terminals of each jack 16 to the output terminal 164 and the supply line 192, respectively. Then the jack 16 can provide power for electronic appliances, for example, a DC motor. In FIG. 3, an integrated appliance 35 has an output terminal 165 electrically connected to the output terminal 164 and a ground line electrically connected to the supply line 192. The integrated appliance 35 is composed of an IC chip 350, a lamp 352, a LED 354, a speaker 356, and a DC motor 358.

The integrated appliance 35 is described in detail as follows. The IC chip 350 is supplied from the output terminal 165 and the supply line 192. A third resist 351 is connected between the IC chip 350 and the LED 354. The speaker 356 is further connected with a fourth resist 353 and a transistor (semi-conductor triode) 357. The IC chip 350 will send a signal to the transistor 357 for controlling the speaker 356. The DC motor 358 is further connected with a fifth resist 355 and a transistor 359. The IC chip 350 will send a signal to the transistor 359 for controlling the DC motor 358.

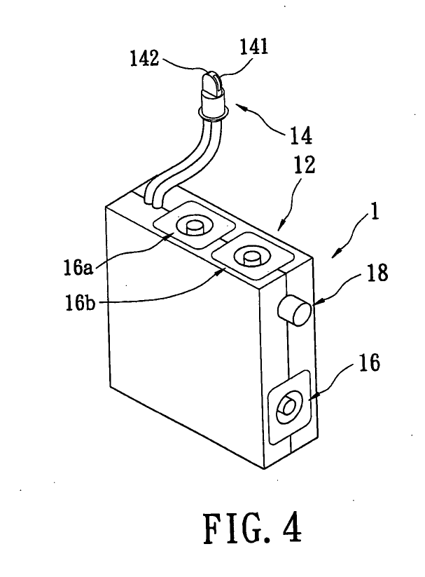

Referring to FIG. 4, which is a perspective view of the power adaptor for Christmas light string of second embodiment according to the present invention. The power adaptor has at least one jack 16, 16a, and 16b, which can provide different voltage, such as 3V or 4.5V in DC. The voltage realm can be 1.0V to 6.0V, and the current value can be 10 mA to 150 mA.

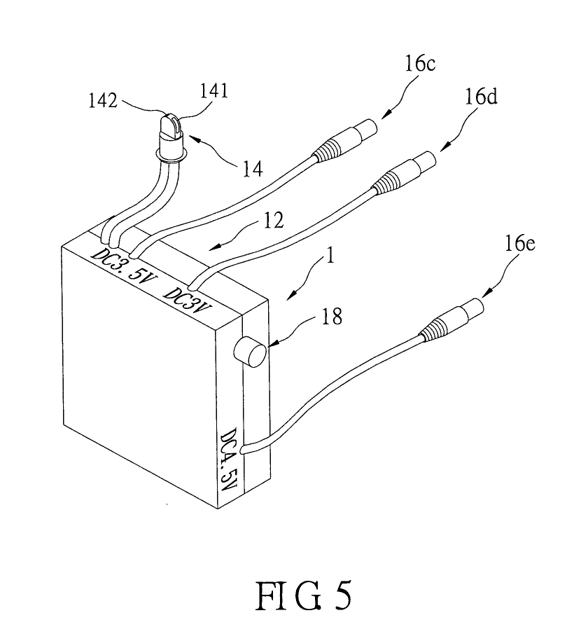

Referring to FIG. 5, which is a perspective view of the power adaptor for Christmas light string of third embodiment according to the present invention. In this embodiment, the output connectors of the power adaptor are plugs 16c, 16d, and 16e. The housing 12 is further marked with voltage values thereon, which are corresponding to plugs 16c, 16d, and 16e, such as AC 110V, DC 3V, and DC 4.5V

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A power adaptor for Christmas light string, said Christmas light string having a plurality of sockets, comprising:
an insulative housing;
a PCB, received in said insulative housing, said PCB having at least one output connector for supplying electrical power to ornaments and a switch mounted thereon;
a plug, electrically coupled to said PCB, and inserted into one of said socket of said Christmas light string, said plug having a pair of contacts; and
a rectifier means, mounted on said PCB for rectifying AC power to DC power and transmitting said DC power to said output connector through said switch.

2. The power adaptor for Christmas light string as claimed in claim 1, wherein said housing is composed with two half-housings, said two half-housings are screwed to each other.

3. The power adaptor for Christmas light string as claimed in claim 1, wherein said rectifier means has a resistor and four bridge rectifiers.

4. The power adaptor for Christmas light string as claimed in claim 1, wherein said rectifier means further has a Zener diode.

5. The power adaptor for Christmas light string as claimed in claim 1, wherein said rectifier means further has a capacitor.

6. The power adaptor for Christmas light string as claimed in claim 1, wherein said output connectors supply different voltage.

7. The power adaptor for Christmas light string as claimed in claim 1, wherein said output connector is a jack.

8. The power adaptor for Christmas light string as claimed in claim 1, wherein said output connector is a plug.
